(19) United States
(12) Patent Application Publication
(10) Pub. No.: US 2012/0000961 A1
(43) Pub. Date: Jan. 5, 2012

(54) Combustion Nailing Tool

(76) Inventor: Yimin Zhu, Chongqing (CN)

(21) Appl. No.: 12/830,177

(22) Filed: Jul. 2, 2010

(51) Int. Cl. B25C 1/14

(52) U.S. Cl. 227/10

(57) ABSTRACT

A combustion nailing tool includes a tool body, a one-way valve, a cover disposed on the one-way valve, and a housing including a housing body and a cap. The tool body includes a combustion cylinder formed with an exhaust vent. The one-way valve is disposed on the combustion cylinder to cover an outer side of the exhaust vent, and is configured to allow exhaust gas resulting from ignition in the combustion cylinder to be vented through the exhaust vent. The cover has an open end allowing the exhaust gas to flow therethrough. The housing body defines an accommodating space for containing the combustion cylinder, and an opening in flow communication with the accommodating space and registered with the cover. The cap is mounted removably on the housing body and covers a part of the opening to thereby allow the exhaust gas to flow out of the housing.

### BACKGROUND OF THE INVENTION

1. Field of the Invention

The present invention relates to a combust ion nailing tool, more particularly to a combustion nailing tool driven by a high pressure generated upon ignition of flammable gas in a combustion cylinder.

2. Description of the Related Art

Referring to FIGS. 1 and 2, a conventional combustion nailing tool 1 includes a housing 11, a cap 12, a combustion cylinder 13, and a firing mechanism 149. The firing mechanism 149 is driven by a high pressure generated upon ignition of flammable gas to fire a nail. The housing 11 defines an accommodating space 111 for containing the combustion cylinder 13, and is formed with an opening 112 at a front end of the housing 11. The cap 12 is mounted on a back end of the housing 11 and closes the accommodating space 111 to thereby position the combustion cylinder 13 in the accommodating space 111.

The combustion cylinder 13 includes a cylinder body 130 that is formed with a plurality of exhaust vents 131, and that includes a surrounding wall 132 encompassing the exhaust vents 131. The combustion cylinder 13 further includes a gasket 133 disposed on a top end of the surrounding wall 132, a filter screen 134 disposed in the gasket 133, and a mounting plate 135. The mounting plate 135 abuts against top surfaces of the gasket 133 and the filter screen 134. A pair of first screws 136 extend through two of four first through holes 137 in the mounting plate 135 and two of four second through holes 138 in the gasket 133, and threadedly engages two of four screw holes 139 formed on the top end of the surrounding wall 132 to thereby mount the mounting plate 135 and the gasket 133 on the top end of the surrounding wall 132. By virtue of the gasket 133, exhaust gas resulting from the ignition of the flammable gas in the combustion cylinder 13 will be vented through the filter screen 134 and a plurality of ventholes 140 in the mounting plate 135 in sequence.

The combustion cylinder 13 further includes a one-way valve 141, a filter core 142, and a cover 143. The one-way valve 141 is disposed on a top surface of the mounting plate 135, and includes a plurality of covering plates 144 for covering the ventholes 140, respectively. By virtue of the covering plates 144 of the one-way valve 141, a negative pressure will be generated inside the combustion cylinder 13 after the ignition of the flammable gas to thereby restore the firing mechanism 149 after firing a nail. The cover 143 is mounted on the one-way valve 141, and includes a stop 145 disposed inside the cover 143 at a front end thereof. The filter core 142 is disposed at a front end of the one-way valve 141, and abuts against a rear side of the stop 145 for filtering out contaminants in the exhaust gas. A pair of second screws 146 extend through a pair of third through holes 147 in the cover 143, a pair of fourth through holes 148 in the one-way valve 141, the other two of the first through holes 137 in the mounting plate 135 and the other two of the second through holes 138 in the gasket 133, and threadedly engages the other two of the screw holes 139 formed on the top end of the surrounding wall 132 to thereby mount the cover 143, the one-way valve 141, the mounting plate 135 and the gasket 133 on the top end of the surrounding wall 132. The cover 143 is configured to change a flow direction of the exhaust gas vented through the ventholes 140 to thereby allow the exhaust gas to flow through the filter core 142 and then to flow out of the housing 11 through the opening 112 of the housing 11.

Since the conventional combustion nailing tool 1 is driven by the high pressure generated upon the ignition of the flammable gas in the combustion cylinder 13, carbon deposit, grease, etc. will accumulate in the combustion cylinder 13 after a period of use. Therefore, the conventional combustion nailing tool 1 requires regular cleaning.

It is inconvenient to clean the conventional combustion nailing tool 1 since it includes relatively many components between the exhaust vents 131 in the combustion cylinder 13 and the opening 112 of the housing 11. When it is desired to clean the components of the combustion cylinder 13, first, the cap 12 is removed from the housing 11 and the combustion cylinder 13 is taken out of the accommodating space 111. Subsequently, the cover 143, the filter core 142 and the one-way valve 141 are unscrewed and removed for cleaning, followed by removal of the mounting plate 135, the filter screen 134 and the gasket 133. Cleaning of the combustion cylinder 13 requires relatively complicated disassembly and assembly processes.

Moreover, since the filter screen 134 and the mounting plate 135 are disposed between the one-way valve 141 and the surrounding wall 132, the filter screen 134 and the mounting plate 135 may block part of the exhaust gas vented through the exhaust vents 131 to the one-way valve 141, such that the exhaust gas cannot be vented completely. Thus, heat cannot be dissipated effectively and the cylinder body 130 of the combustion cylinder 13 may overheat.

### SUMMARY OF THE INVENTION

Therefore, an object of the present invention is to provide a combustion nailing tool that is convenient to disassemble and assemble.

Another object of the present invention is to provide a combustion nailing tool capable of smooth venting of exhaust gas and of dissipating heat effectively.

Accordingly, a combustion nailing tool of the present invention comprises a tool body, a one-way valve, a cover, and a housing.

The tool body includes a combustion cylinder that defines an ignition chamber and that is formed with an exhaust vent in flow communication with the ignition chamber. The tool body further includes a firing mechanism coupled to and operatively associated with the combustion cylinder for firing a nail when flammable gas in the ignition chamber is ignited. The one-way valve is disposed on the combustion cylinder to cover an outer side of the exhaust vent, and is configured to allow exhaust gas resulting from ignition of the flammable gas in the ignition chamber to be vented through the exhaust vent. The cover is disposed on the one-way valve, and has a connecting end connected to the one-way valve and an open end that is opposite to the connecting end and that allows the exhaust gas vented through the exhaust vent and the one-way valve to flow therethrough. The housing includes a housing body and a cap. The housing body defines an accommodating space for containing the combustion cylinder, and an opening in flow communication with the accommodating space and registered with the cover. The cap is mounted removably on the housing body and covers a part of the opening to thereby allow the exhaust gas flowing through the open end of the cover to flow out of the housing.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing a part of a conventional combustion nailing tool;

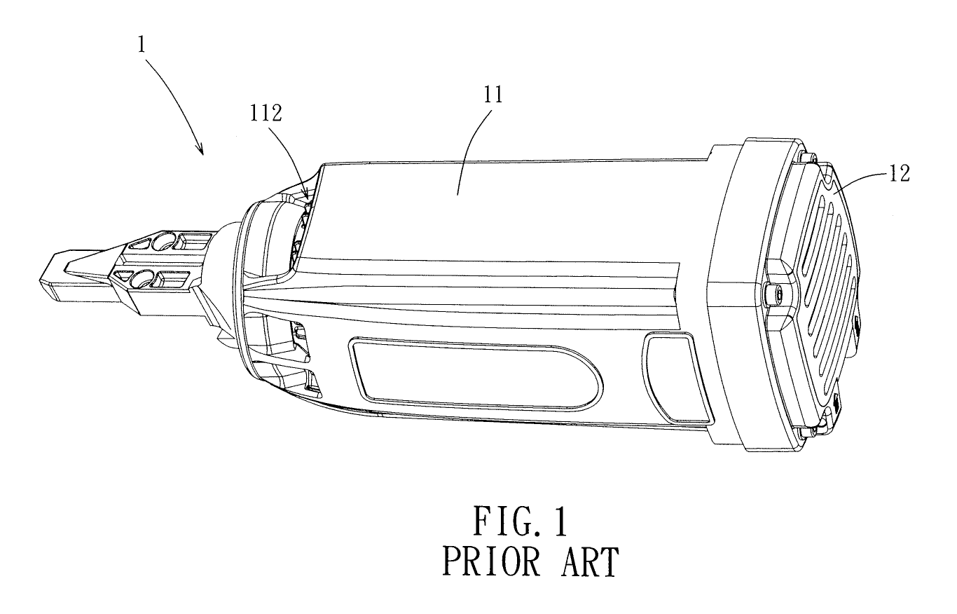

FIG. 2 is an exploded perspective view illustrating components of a combustion cylinder of the conventional combustion nailing tool;

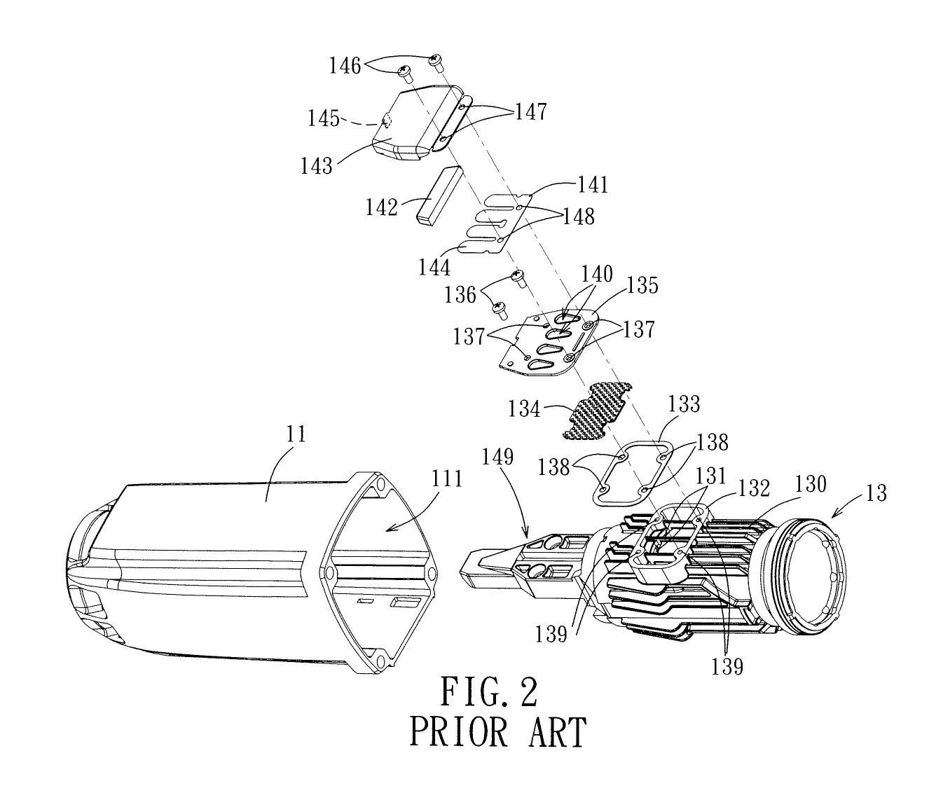

FIG. 3 is a side view of a first preferred embodiment of a combustion nailing tool of the present invention;

FIG. 4 is a partly exploded perspective view of a part of the combustion nailing tool of the first preferred embodiment;

FIG. 5 is a sectional view of the combustion nailing tool of the first preferred embodiment for illustrating covering plates of a one-way valve in a covering position;

FIG. 6 is a sectional view of the combustion nailing tool of the first preferred embodiment for illustrating the covering plates of the one-way valve in an uncovering position;

FIG. 7 is a partly exploded perspective view of a second preferred embodiment of a combustion nailing tool of the present invention;

FIG. 8 is a partly exploded perspective view of a third preferred embodiment of a combustion nailing tool of the present invention;

FIG. 9 is a partly exploded perspective view of a modification of the combustion nailing tool of the third preferred embodiment;

FIG. 10 is a partly exploded perspective view of a fourth preferred embodiment of a combustion nailing tool of the present invention; and

FIG. 11 is a partly exploded perspective view of a modification of the combustion nailing tool of the fourth preferred embodiment.

### DETAILED DESCRIPTION OF THE PREFERRED EMBODIMENTS

Before the present invention is described in greater detail, it should be noted that like elements are denoted by the same reference numerals throughout the disclosure.

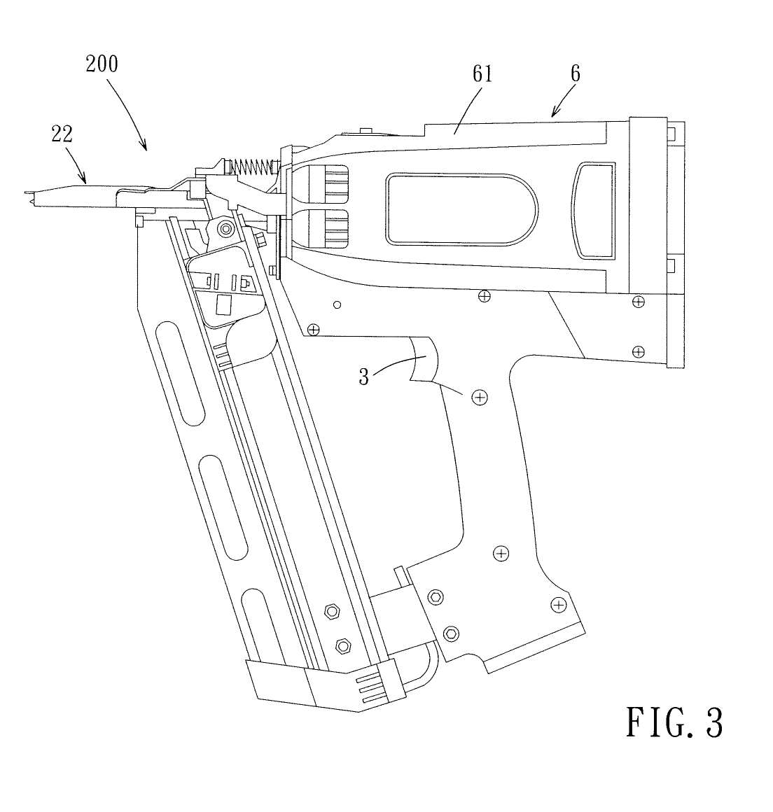

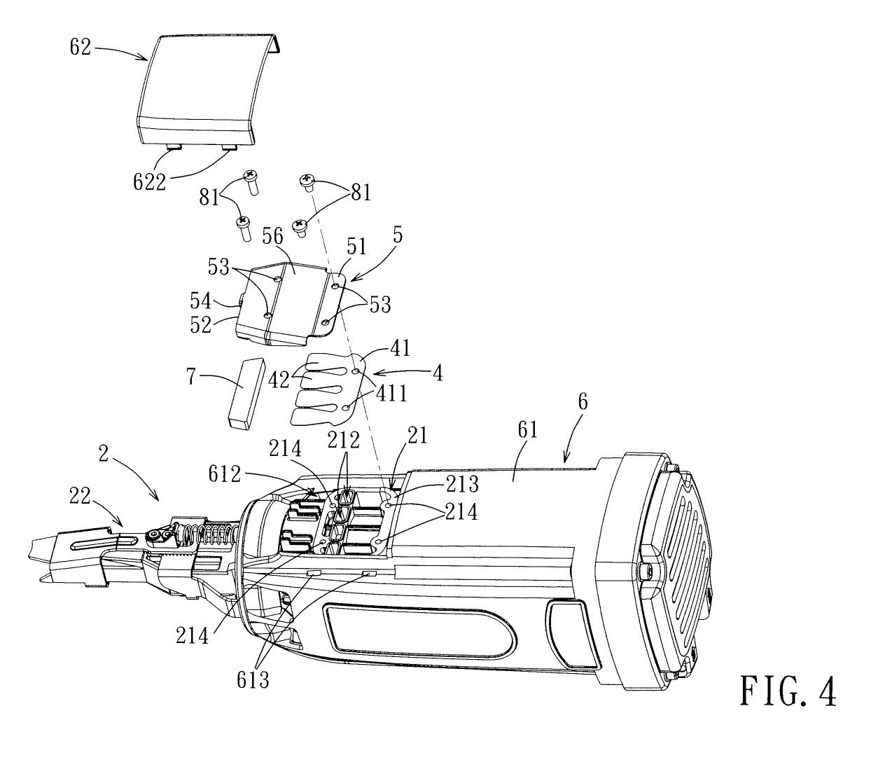

Referring to FIGS. 3 to 5, a first preferred embodiment of a combustion nailing tool 200 according to this invention includes a tool body 2, a trigger mechanism 3, a one-way valve 4, a cover 5 and a housing 6.

The tool body 2 includes a combustion cylinder 21 and a firing mechanism 22 disposed at a front end of the combustion cylinder 21. The combustion cylinder 21 defines an ignition chamber 211, and the firing mechanism 22 is coupled to and is operatively associated with the combustion cylinder 21 for firing a nail when flammable gas in the ignition chamber 211 is ignited. The trigger mechanism 3 is coupled to the tool body 3, and is operable to make a spark plug (not shown) ignite the flammable gas in the ignition chamber 211 to result in a high pressure to thereby drive the firing mechanism 22 to fire a nail. Since the operation of the combustion nailing tool 200 to fire a nail is similar to the operation of a conventional combustion nailing tool, details thereof will be omitted herein for the sake of brevity. The combustion cylinder 21 is further formed with a plurality of exhaust vents 212 in flow communication with the ignition chamber 211, and includes a surrounding wall 213 that surrounds the exhaust vents 212 and that is formed with a plurality of first screw holes 214.

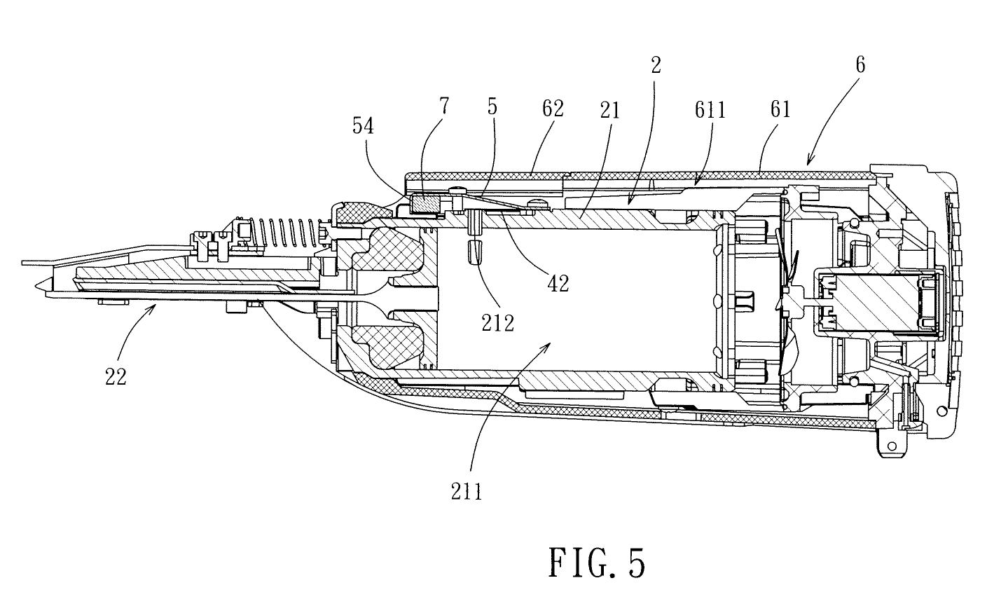

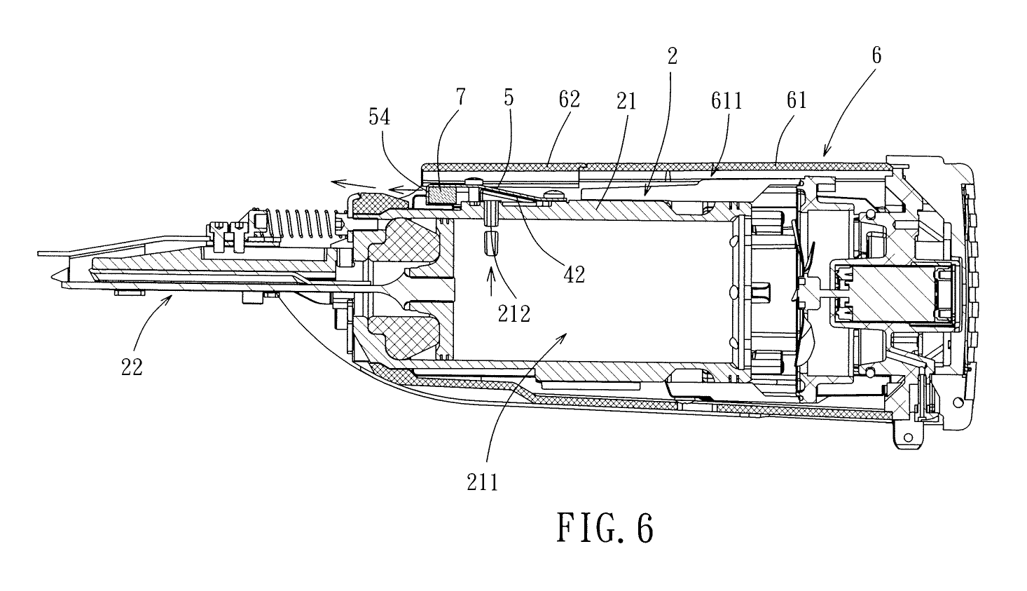

The one-way valve 4 is disposed on the surrounding wall 213 of the combustion cylinder 212, and covers an outer side of the exhaust vents 212. The one-way valve 4 is a plate made of flexible metal, and includes a connecting part 41 connected to the surrounding wall 213 and a plurality of covering plates 42 extending forwardly from the connecting part 41. The connecting part 41 is formed with a pair of first through holes 411 respectively aligned with a rear pair of the first screw holes 214 in the surrounding wall 213. A number of the covering plates 42 is equal to a number of the exhaust vents 212, and the covering plates 42 are registered with the exhaust vents 212, respectively. Each of the covering plates 42 has an elongated shape, and an area thereof is larger than that of each of the exhaust vents 212. Generally, as shown in FIG. 5, the covering plates 42 are in a covering position where the covering plates 42 cover the exhaust vents 212, respectively. The high pressure generated upon ignition of the flammable gas in the ignition chamber 211 will push the covering plates 42 to an uncovering position where the covering plates 42 do not cover the exhaust vents 212 as shown in FIG. 6, to thereby allow exhaust gas resulting from ignition of the flammable gas in the ignition chamber 211 to be vented through the exhaust vents 212. After the exhaust gas is vented, the covering plates 42 will be restored to the covering position due to the resiliency thereof, such that a negative pressure is generated in the ignition chamber 211 to thereby restore the firing mechanism 22 after firing a nail.

The cover 5 is disposed on the one-way valve 4, and has a connecting end 51, an open end 52 opposite to the connecting end 51, and a middle portion 56 between the connecting end 51 and the open end 52. The connecting end 51 is formed with a pair of second through holes 53 respectively aligned with the first through holes 411 in the connecting part 41 of the one-way valve 4, and the middle portion 56 is also formed with a pair of the second through holes 53 respectively aligned with a front pair of the first screw holes 214 in the surrounding wall 213. The cover 5 and the one-way valve 4 are screwed on the combustion cylinder 21 via four first screws 81. Two of the first screws 81 extend through the second through holes 53 in the middle portion 56 of the cover 5 and threadedly engage the front pair of the first screw holes 214 in the surrounding wall 213, and the other two of the first screws 81 extend through the second through holes 53 in the connecting end 51 of the cover 5 and the first through holes 411 in the connecting part 41 of the one-way valve 4 and threadedly engage the rear pair of the first screw holes 214 in the surrounding wall 213. The open end 52 is in front of the covering plates 42 of the one-way valve 4, and allows the exhaust gas vented through the exhaust vents 212 and the one-way valve 4 to flow therethrough.

The cover 5 includes a stop 54 disposed at the open end 52. The combustion nailing tool 200 further includes a filter core 7 that is disposed between the covering plates 42 of the one-way valve 4 and the open end 52 of the cover 5 and that abuts against a rear side of the stop 54 of the cover 5. The filter core 7 is disposed in a flow path of the exhaust gas for filtering out contaminants in the exhaust gas so as to reduce air pollution attributed to the exhaust gas flowing out of the open end 52.

The housing 6 includes a housing body 61 and a cap 62. The housing body 61 defines an accommodating space 611 for containing the combustion cylinder 21, and an opening 612 in flow communication with the accommodating space 611 and registered with the cover 5. The housing body 611 is formed with a plurality of retaining grooves 613 around the opening 612, and the cap 62 is formed with a plurality of retaining tongues 622 at a bottom side thereof. A number of the retaining tongues 622 is equal to a number of the retaining grooves 613, and the retaining tongues 622 are registered with the retaining grooves 613 so as to engage the retaining grooves 613, respectively. Through engagement between the retaining tongues 622 on the cap 62 and the retaining grooves 613 in the housing body 61, the cap 62 is mounted removably on the housing body 61. Since an area of the cap 62 is smaller than that of the opening 612 of the housing body 61, the cap 62 covers a part of the opening 612 to thereby allow the exhaust gas flowing through the open end 52 of the cover 5 to flow out of the housing 6. In this embodiment, a front portion of the opening 612 is not covered by the cap 62, and thus the exhaust gas flows out of the housing 6 through the front portion of the opening 612.

When it is desired to clean the combustion nailing tool 200, the cap 62 is removed from the housing body 61 such that the opening 612 of the housing body 61 is completely uncovered. Then, the first screws 81 are loosened and removed from the screw holes 214 in the surrounding wall 213, such that the cover 5 and the one-way valve 4 can be disassembled for cleaning the one-way valve 4, the cover 5, the filter core 7 and the exhaust vents 212.

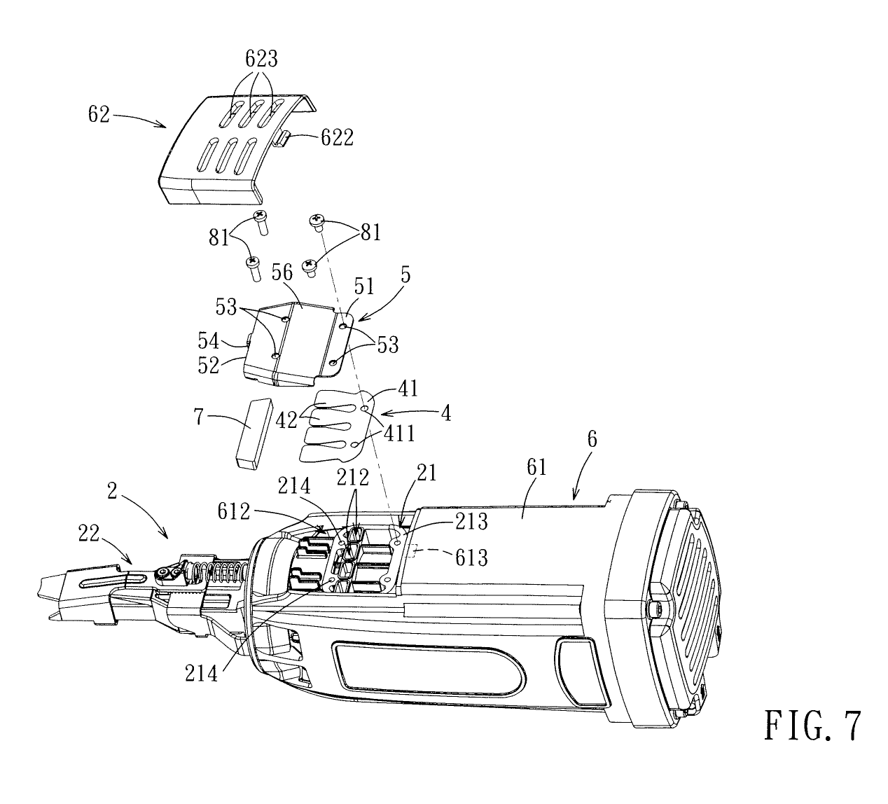

Referring to FIG. 7, a second preferred embodiment of the combustion nailing tool of this invention is shown to be similar to the first preferred embodiment. In this embodiment, the housing body 61 of the housing 6 is formed with only one retaining groove 613, and the cap 62 of the housing 6 is formed with only one retaining tongue 622. In addition, the cap 62 is further formed with a plurality of holes 623 for heat-dissipation. By virtue of the holes 623, efficiency of heat-dissipation can be enhanced when the combustion cylinder 21 vents the exhaust gas.

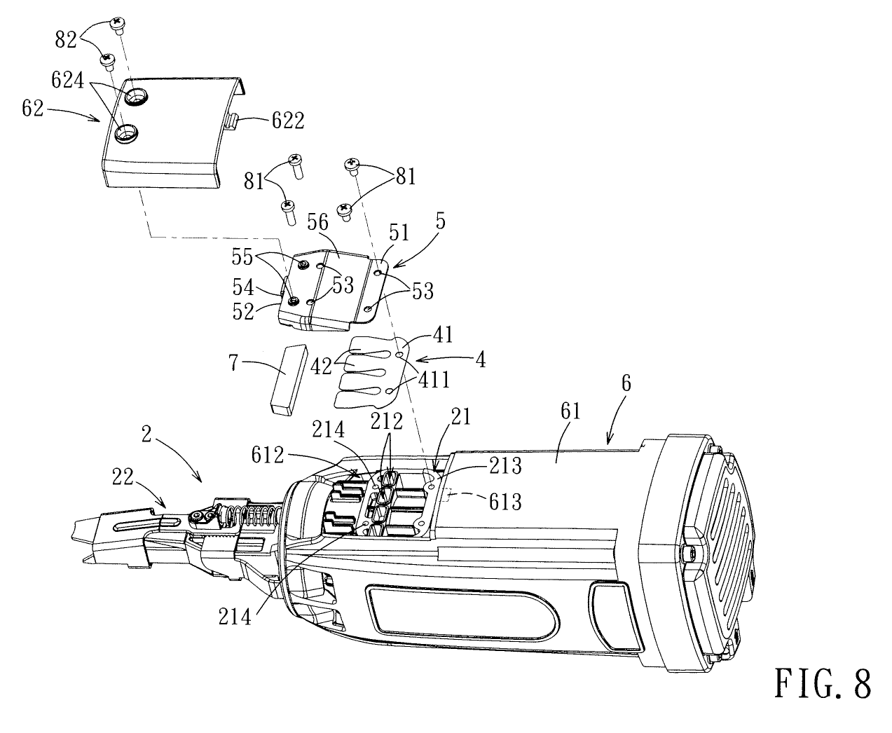

Referring to FIG. 8, a third preferred embodiment of the combustion nailing tool of this invention is shown to be similar to the first preferred embodiment. In the third preferred embodiment, the housing body 61 of the housing 6 is formed with only one retaining groove 613, and the cap 62 of the housing 6 is formed with only one retaining tongue 622. In addition, the cover 5 is further formed with a pair of second screw holes 55 in an outer side thereof, and the cap 62 is further formed with a pair of third through holes 624 aligned with the second screw holes 55 in the cover 5, respectively. The cap 62 is screwed on the cover 5 via a pair of second screws 82 extending through the third through holes 624 and threadedly engaging the second screw holes 55, respectively. Therefore, the cap 62 is relatively securely mounted on the housing body 61 and the cover 5.

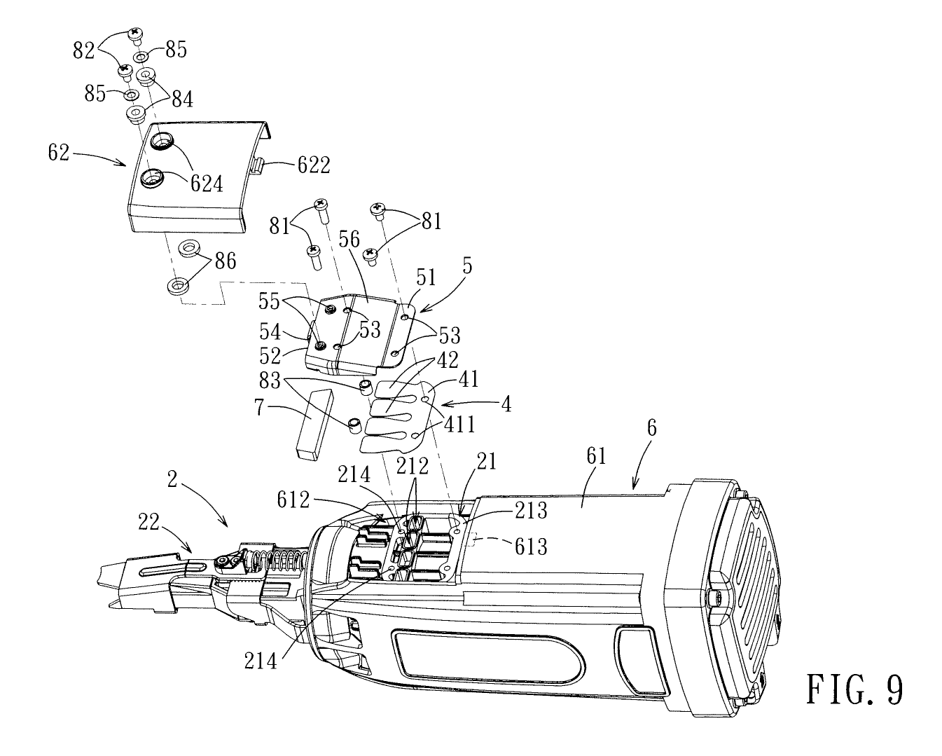

As shown in FIG. 9, in this embodiment, a pair of nuts 83 are disposed between the cover 5 and the surrounding wall 213 of the combustion cylinder 21. Two of the first screws 81 extend through the second through holes 53 in the middle portion 56 of the cover 5 and the nuts 83, and threadedly engage the nuts 83 and the front pair of the first screw holes 214 in the surrounding wall 213, respectively. In addition, each of the third through holes 624 is provided with a heat-insulating plug 84 and a washer 85 therein, and a pair of heat-insulating sleeves 86 are disposed between the cover 5 and the cap 62 of the housing 6. The second screws 82 extend in sequence through the washers 85, the heat-insulating plugs 84 and the heat-insulating sleeves 86, and threadedly engage the second screw holes 55 in the cover 5, respectively. The heat-insulating plugs 84 and the heat-insulating sleeves 86 are made of a material, such as rubber or silicone, with relatively lower heat conductivity, and therefore can reduce heat conduction from the cover 5 to the cap 62 through the metallic second screws 82 so as to prevent the cap 62 from damage.

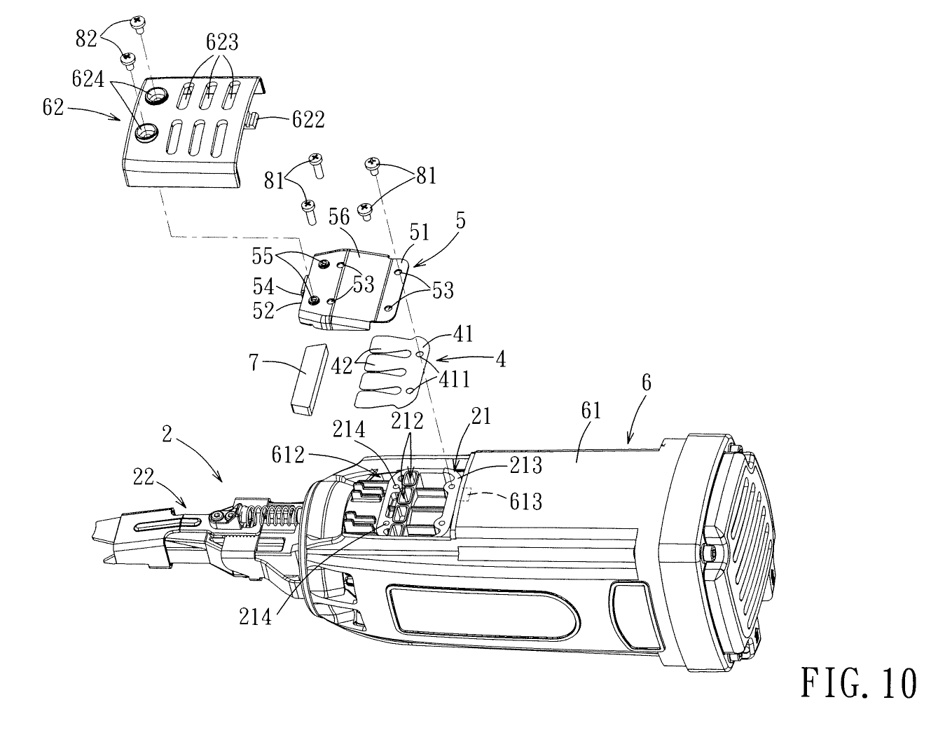

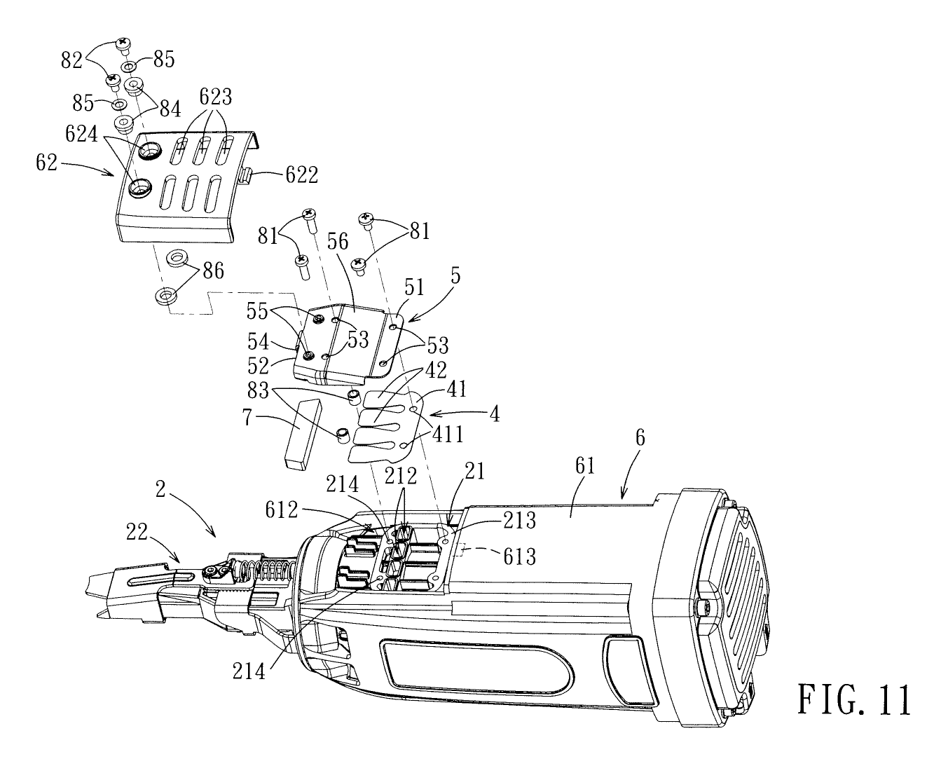

Referring to FIG. 10, a fourth preferred embodiment of the combustion nailing tool of this invention is shown to be similar to the second preferred embodiment. In this embodiment, the cover 5 is further formed with a pair of second screw holes 55 in an outer side thereof, and the cap 62 is further formed with a pair of third through holes 624 aligned with the second screw holes 55 in the cover 5, respectively. The cap 62 is screwed on the cover 5 via a pair of second screws 82 extending through the third through holes 624 and threadedly engaging the second screw holes 55, respectively. As shown in FIG. 11, in this embodiment, a pair of nuts 83, a pair of heat-insulating plugs 84, a pair of washers 85 and a pair of heat-insulating sleeves 86 are also provided as described in the third preferred embodiment.

In conclusion, by virtue of the opening 612 of the housing body 61 and the cap 62 mounted removably on the housing body 61, it is not required to take the combustion cylinder 21 out of the accommodating space 611 when cleaning. Moreover, since components of the combustion nailing tool 200 according to this invention are fewer in number, it is relatively easier to disassemble and assemble the combustion nailing tool 200. Further, since there are relatively less components disposed in the flow path of the exhaust gas, the exhaust gas will relatively flow smoothly out of the housing 6. Therefore, the heat-dissipation is relatively effective so as to prevent the combustion cylinder 21 from overheating.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A combustion nailing tool comprising:
a tool body including a combustion cylinder that defines an ignition chamber and that is formed with an exhaust vent in flow communication with said ignition chamber, said tool body further including a firing mechanism coupled to and operatively associated with said combustion cylinder for firing a nail when flammable gas in said ignition chamber is ignited;
a one-way valve disposed on said combustion cylinder to cover an outer side of said exhaust vent, said one-way valve being configured to allow exhaust gas resulting from ignition of the flammable gas in said ignition chamber to be vented through said exhaust vent;
a cover disposed on said one-way valve, and having a connecting end connected to said one-way valve and an open end that is opposite to said connecting end and that allows the exhaust gas vented through said exhaust vent and said one-way valve to flow therethrough; and
a housing that includes
a housing body defining an accommodating space for containing said combustion cylinder, and an opening in flow communication with said accommodating space and registered with said cover, and
a cap mounted removably on said housing body and covering a part of said opening to thereby allow the exhaust gas flowing through said open end of said cover to flow out of said housing, wherein removal of said cap provides access to said cover when said combustion cylinder is within said accommodating space.

2. The combustion nailing tool as claimed in claim 1, wherein said cap of said housing is formed with a plurality of holes for heat-dissipation.

3. The combustion nailing tool as claimed in claim 1, wherein said housing body of said housing is formed with a retaining groove, and said cap of said housing is formed with a retaining tongue for engaging said retaining groove.

4. The combustion nailing tool as claimed in claim 3, wherein said cap of said housing is formed with a plurality of holes for heat-dissipation.

5. The combustion nailing tool as claimed in claim 4, wherein said cover is formed with a plurality of screw holes, said cap of said housing is further formed with a plurality of through holes respectively aligned with said screw holes, and said combustion nailing tool further comprises a plurality of screws extending through said through holes and threadedly engaging said screw holes, respectively.

6. The combustion nailing tool as claimed in claim 5, further comprising a plurality of heat-insulating sleeves disposed between said cover and said cap of said housing, and a plurality of heat-insulating plugs respectively disposed in said through holes, said screws extending through said heat-insulating sleeves and said heat-insulating plugs, respectively.

7. The combustion nailing tool as claimed in claim 3, wherein said cover is formed with a plurality of screw holes, said cap of said housing is formed with a plurality of through holes respectively aligned with said screw holes, and said combustion nailing tool further comprises a plurality of screws extending through said through holes and threadedly engaging said screw holes, respectively.

8. The combustion nailing tool as claimed in claim 7, further comprising a plurality of heat-insulating sleeves disposed between said cover and said cap of said housing, and a plurality of heat-insulating plugs respectively disposed in said through holes, said screws extending through said heat-insulating sleeves and said heat-insulating plugs, respectively.

9. The combustion nailing tool as claimed in claim 1, wherein said one-way valve is a flexible plate.
